(19) United States
(12) Patent Application Publication
(10) Pub. No.: US 2012/0028875 A1
(43) Pub. Date: Feb. 2, 2012

(54) MICROEMULSION LIQUID CLEANING COMPOSITIONS

(75) Inventor: John Kordosh, Simi Valley, CA (US)

(73) Assignee: HOMAX PRODUCTS, INC., Bellingham, WA (US)

(21) Appl. No.: 13/192,723

(22) Filed: Jul. 28, 2011

Related U.S. Application Data
(60) Provisional application No. 61/369,017, filed on Jul. 29, 2010.

(51) Int. Cl. C11D 17/00

(52) U.S. Cl. 510/405

(57) ABSTRACT

A liquid cleaning composition having a base comprising an inert liquid, approximately 10-40% by weight of at least one cleaning component selected from the group of cleaning components comprising d-limonene, dibasic esters, heptanes and other paraffins, isoparaffins, isopraffinic mixtures, and aromatic solvents, approximately 5-20% by weight of a first co-surfactant, and approximately 1-20% by weight of a second co-surfactant.

### RELATED APPLICATIONS

This application (Attorney's Ref. No. P216766) claims benefit of U.S. Provisional Application Ser. No. 61/369,017 filed Jul. 29, 2010, the contents of which are incorporated herein by reference.

### TECHNICAL FIELD

The present invention relates to cleaning compositions and, in particular, to liquid cleaning compositions.

### BACKGROUND

Traditionally, effective liquid cleaning compositions have been formulated using solvents, such as hydrocarbon solvents, as a base. Recently, attempts have been made to develop liquid cleaning compositions that employ lower levels of solvents.

One such class of low solvent liquid cleaning composition employs microemulsions. Microemulsions are clear, thermodynamically stable dispersions of oil (solvent) in water in which the cleaning abilities of the solvents are not greatly impaired by the presence of the water.

However, reduction of the use of solvents has sometimes been correlated with reduced stability and/or effectiveness of the cleaning composition.

The need thus exists for improved liquid cleaning compositions that employ dispersions of oil in a water base yet offer stability and cleaning effectiveness approaching that of solvent based liquid cleaning compositions.

### SUMMARY

The present invention may be embodied as a liquid cleaning composition comprising a base comprising an inert liquid, approximately 10-40% by weight of at least one cleaning component selected from the group of cleaning components comprising d-limonene, dibasic esters, heptanes and other paraffins, isoparaffins, isopraffinic mixtures, and aromatic solvents, approximately 5-20% by weight of a first co-surfactant, and approximately 1-20% by weight of a second co-surfactant.

The present invention may also be embodied as a method of forming a liquid cleaning composition comprising the following steps. A base comprising an inert liquid is provided. A mixture is formed by adding to the base at least one cleaning composition, at least one first co-surfactant, and at least one second co-surfactant. The at least one cleaning composition comprises approximately 10-40% by weight of the liquid cleaning composition and is selected from the group of cleaning components comprising d-limonene, dibasic esters, heptanes and other paraffins, isoparaffins, isopraffinic mixtures, and aromatic solvents. The first co-surfactant comprises approximately 5-20% by weight of the liquid cleaning composition. The second co-surfactant comprises approximately 1-20% by weight of the liquid cleaning composition. The mixture is stirred to obtain a microemulsion.

The present invention may also be embodied as a cleaning composition comprising a base comprising an inert liquid, approximately 2-15% by weight of a first cleaning component, approximately 8-25% by weight of a second cleaning component, approximately 5-20% by weight of a first co-surfactant, and approximately 1-20% by weight of a second co-surfactant.

The present invention may also be embodied as a liquid cleaning composition comprising a base comprising an inert liquid, approximately 1-15% by weight of a first cleaning component, approximately 5-25% by weight of a second cleaning component, approximately 1-10% by weight of a third cleaning component, approximately 2-10% by weight of a first co-surfactant; and approximately 1-20% by weight of a second co-surfactant.

### DETAILED DESCRIPTION

The present invention may be embodied as a liquid cleaning composition in the form of a micoremulsion of organic solvents dispersed in water. In general, a liquid cleaning composition constructed in accordance with the principles of the present invention comprises water as a base or carrier, one or more cleaning components such as d-limonene, dibasic esters, aliphatic hydrocarbon, and/or soy esters, a first co-surfactant such as diethylhexyl sodium sulfosuccinate (Aerosol OT), and a second co-surfactant such as hexyl carbitol.

Blending these materials achieves a liquid cleaning composition in the form of a clear microemulsion. This liquid cleaning composition of the present invention is comprised primarily of water and has cleaning properties that are at least as desirable as conventional liquid cleaning compositions composed primarily of solvents.

The following Table 1 lists ingredients (by percent weight) of a generic liquid cleaning composition constructed in accordance with, and embodying, the present invention:

TABLE 1
GENERIC LIQUID CLEANING COMPOSITION

| | Generic | First | Second |
|---|---|---|---|
| Material | Example | Range | Range |
| Base | ~68% | 58-78% | >40% |
| Cleaning Component(s) | ~18% | 12-24% | 10-40% |
| First Co-Surfactant | ~10% | 6-15% | 5-20% |
| Second Co-Surfactant | ~5% | 2-12% | 1-20% |

The base will typically be any inexpensive, inert liquid such as water. The cleaning component is typically one or more cleaning components selected from the group of solvents consisting of d-limonene, dibasic esters, heptanes and other paraffins, isoparaffins, isopraffinic mixtures (e.g., Exxsol D-95), and aromatic solvents. The example first co-surfactant is a surfactant such as Hexyl carbitol, but the first co-surfactant may be one or more surfactant selected from the group consisting of hexyl carbitol, butyl cellosolve, and butyl carbitol. The example second co-surfactant is a surfactant such as diethylhexyl sodium sulfosuccinate (e.g., Aerosol OT; known chemically as sodium bis(2-ethylhexyl) sulfosuccinate).

The resulting compositions can be quite low in VOC (volatile organic compounds)—even as low as 0%—and still be effective as a multi-purpose cleaner.

The liquid cleaning composition of the present invention is used by applying the composition, either directly or indirectly (e.g., using a rag or sponge) to unwanted stains and marks. Liquid cleaning compositions of the present invention have been used to remove tar, paint, ink, crayon, Sharpie marker, gym, caulk, wax, and oil. The liquid cleaning compositions of the present invention have achieved excellent results in comparison to existing conventional liquid cleaning products. The following Table 2 lists ingredients (by percent weight) of a first example liquid cleaning composition constructed in accordance with, and embodying, the present invention:

TABLE 2
FIRST EXAMPLE LIQUID CLEANING COMPOSITION

| | | Generic | First | Second |
|---|---|---|---|---|
| Material | Purpose | Example | Range | Range |
| Water | Base | ~68.2% | 58-78% | >40% |
| d-limonene | First Cleaning | ~4.8% | 3-6% | 2-15% |
| | Component | | | |
| dibasic esters | Second Cleaning | ~12% | 1-15% | 8-25% |
| (DBE-LVP) | Component | | | |
| Hexyl carbitol | First | ~10% | 6-15% | 5-20% |
| | Co-Surfactant | | | |
| diethylhexyl sodium | Second | ~5% | 2-12% | 1-20% |
| sulfosuccinate | Co-Surfactant | | | |
| (Aerosol OT) | | | | |

The mixture of materials forming the first example liquid cleaning material of the present invention can be blended with stirring; no remarkable shear is necessary to achieve the clear microemulsion.

Other solvents can be substituted for the d-limonene and dibasic esters and result in effective microemulsions. Examples of other solvents that may be used in addition to and/or instead of the d-limonene and dibasic esters include heptane, isopraffinic mixtures like Exxsol D-95, and aromatic solvents. Chemically similar solvents such as butyl cellosolve and butyl carbitol, may be used in place of the Hexyl carbitol, but Hexyl carbitol is preferred. If Aerosol OT is used as the second co-surfactant, low amounts (e.g., as low as 1%) of the second co-surfactant can be used and still achieve microemulsions.

The following Table 3 lists ingredients (by percent weight) of a second example liquid cleaning composition constructed in accordance with, and embodying, the present invention:

TABLE 3
SECOND EXAMPLE LIQUID CLEANING COMPOSITION

| | | Generic | First | Second |
|---|---|---|---|---|
| Material | Purpose | Example | Range | Range |
| Water | Base | ~57% | 50-60% | >40% |
| d-limonene (Orange | First Cleaning | ~2% | 1-5% | 1-15% |
| Oil) | Component | | | |
| Aliphatic | Second Cleaning | ~18% | 15-20% | 5-25% |
| hydrocarbon | Component | | | |
| Soy Esters | Third Cleaning | ~3% | 2-5% | 1-10% |
| | Component | | | |
| Hexyl carbitol | First | ~7.5% | 5-10% | 2-20% |
| | Co-Surfactant | | | |
| diethylhexyl sodium | Second | ~10% | 2-15% | 1-20% |
| sulfosuccinate | Co-Surfactant | | | |
| (Aerosol OT) | | | | |

The d-limonene, or orange oil, cleaning component is a solvent with a mild orange scent. The aliphatic hydrocarbon cleaning component is a mild, low-odor solvent effective on hydrocarbon-type materials such as tar. The soy esters cleaning component is a slightly more polar low odor solvent.

Again, chemically similar solvents such as butyl cellosolve and butyl carbitol, may be used in place of the Hexyl carbitol, but Hexyl carbitol is preferred. If Aerosol OT is used as the second co-surfactant, low amounts (e.g., as low as 1%) of the second co-surfactant can be used and still achieve microemulsions.

The materials forming the second example liquid cleaning material of the present invention form a mixture that can be blended to achieve the clear microemulsion simply by stirring.

What is claimed is:

1. A liquid cleaning composition comprising:
a base comprising an inert liquid;
approximately 10-40% by weight of at least one cleaning component selected from the group of cleaning components comprising d-limonene, dibasic esters, heptanes and other paraffins, isoparaffins, isopraffinic mixtures, and aromatic solvents;
approximately 5-20% by weight of a first co-surfactant; and
approximately 1-20% by weight of a second co-surfactant.

2. A liquid cleaning composition as recited in claim 1, in which the first co-surfactant is at least surfactant selected from the group of solvents comprising comprising hexyl carbitol, butyl cellosolve, and butyl carbitol.

3. A liquid cleaning composition as recited in claim 1, in which the second co-surfactant is diethylhexyl sodium sulfosuccinate.

4. A liquid cleaning composition as recited in claim 2, in which the second co-surfactant is diethylhexyl sodium sulfosuccinate.

5. A liquid cleaning composition as recited in claim 1, in which the base is water.

6. A method of forming a liquid cleaning composition comprising the steps of:
providing a base comprising an inert liquid;
forming a mixture by adding to the base
at least one cleaning composition, where the at least one cleaning composition
comprises approximately 10-40% by weight of the liquid cleaning composition, and
is selected from the group of cleaning components comprising d-limonene, dibasic esters, heptanes and other paraffins, isoparaffins, isopraffinic mixtures, and aromatic solvents;
a first co-surfactant, where the first co-surfactant comprises approximately 5-20% by weight of the liquid cleaning composition; and
a second co-surfactant, where the second co-surfactant comprises approximately 1-20% by weight of the liquid cleaning composition; and
stirring the mixture to obtain a microemulsion.

7. A method as recited in claim 6, in which the first co-surfactant is at least surfactant selected from the group of solvents comprising comprising hexyl carbitol, butyl cellosolve, and butyl carbitol.

8. A method as recited in claim 6, in which the second co-surfactant is diethylhexyl sodium sulfosuccinate.

9. A method as recited in claim 2, in which the second co-surfactant is diethylhexyl sodium sulfosuccinate.

10. A liquid cleaning composition as recited in claim 1, in which the base is water.

11. A liquid cleaning composition comprising:
a base comprising an inert liquid;
approximately 2-15% by weight of a first cleaning component;
approximately 8-25% by weight of a second cleaning component;
approximately 5-20% by weight of a first co-surfactant; and
approximately 1-20% by weight of a second co-surfactant.

12. A liquid cleaning composition as recited in claim 11, in which the first cleaning component is d-limonene.

13. A liquid cleaning composition as recited in claim 11, in which the second cleaning component is a dibasic ester.

14. A liquid cleaning composition as recited in claim 11, in which the first co-surfactant is hexyl carbitol.

15. A liquid cleaning composition as recited in claim 11, in which the second co-surfactant is diethylhexyl sodium sulfosuccinate.

16. A liquid cleaning composition comprising:
a base comprising an inert liquid;
approximately 1-15% by weight of a first cleaning component;
approximately 5-25% by weight of a second cleaning component;
approximately 1-10% by weight of a third cleaning component;
approximately 2-10% by weight of a first co-surfactant; and
approximately 1-20% by weight of a second co-surfactant.

17. A liquid cleaning composition as recited in claim 11, in which the first cleaning component is d-limonene.

18. A liquid cleaning composition as recited in claim 11, in which the second cleaning component is an aliphatic hydrocarbon.

19. A liquid cleaning composition as recited in claim 11, in which the third cleaning component is a soy ester.

20. A liquid cleaning composition as recited in claim 11, in which the first co-surfactant is hexyl carbitol.

21. A liquid cleaning composition as recited in claim 11, in which the second co-surfactant is diethylhexyl sodium sulfosuccinate.
